(19) United States
(12) Patent Application Publication
(10) Pub. No.: US 2026/0071463 A1
(43) Pub. Date: Mar. 12, 2026

(54) LOW-POWER LOCKING DEVICE ASSEMBLIES

(71) Applicant: Sargent Manufacturing Company, New Haven, CT (US)

(72) Inventor: Daniel W. Riley, Meriden, CT (US)

(73) Assignee: Sargent Manufacturing Company, New Haven, CT (US)

(21) Appl. No.: 19/300,016

(22) Filed: Aug. 14, 2025

Related U.S. Application Data
(60) Provisional application No. 63/692,817, filed on Sep. 10, 2024.

(51) Int. Cl. E05B 15/04; E05B 47/00; E05B 63/08

(52) U.S. Cl. CPC E05B 15/04; E05B 47/0012; E05B 2015/0448; E05B 2047/0036; E05B 63/08

(57) ABSTRACT

Aspects disclosed herein relate to electrified locking device assemblies and related methods. In some embodiments, a locking device assembly may include a motorized drive assembly for helping return a locking member to its original position following an incomplete door handle actuation. In some embodiments, the drive assembly may include a motor and spring-loaded actuator, which may be permitted to release energy by transferring the stored energy to a pivotable arm of the locking device assembly. In some embodiments, the motorized drive assembly may include two lock springs, each of which may store energy when compressed between a motor-driven shuttle and a proximal wall.

### CROSS-REFERENCE TO RELATED APPLICATIONS

This application claims the benefit under 35 U.S.C. § 119(e) to U.S. Provisional Application Ser. No. 63/692,817, entitled “LOW-POWER LOCKING DEVICE ASSEMBLIES,” filed Sep. 10, 2024, which is incorporated herein by reference.

### FIELD

Disclosed embodiments are related to locking device assemblies. More specifically, systems for low-power motorized locking device assemblies are disclosed.

### BACKGROUND

Conventional locking devices, such as mortise locks, employ a latchbolt and/or a deadbolt to help secure or lock the door in place. Deadbolts typically function through rotation of a deadbolt arm which mates securely around a hub core. The hub core is typically rotatable by a thumb turn or handle on the inside of the door, and a lock cylinder on the outside of the door. Latchbolts typically function through the rotation of a hub. This hub can be blocked from rotating by a locking member. In recent years, access-control technology in locking devices has increasingly shifted from traditional keying systems and mechanical articulation to digital monitoring and electronic actuation. In some instances, the digitization of locking devices has enabled remote locking and unlocking of doors. Locking systems with electronic actuation typically employ motors to drive features (e.g., a locking member) in the absence of a manual input.

### SUMMARY

In one aspect, a locking device assembly is disclosed. The locking device includes a locking member configured to move between a locked position and an unlocked position, a reversible electric motor and a shuttle operably coupled to the motor. The motor is configured to drive the shuttle linearly. The locking device also includes a chassis operatively coupled to the locking member and a first lock spring and a second lock spring. The shuttle is disposed inside of the chassis. The first lock spring is disposed in a first chamber of the chassis and the second lock spring is disposed in a second chamber of the chassis. Compression of at least one of the first lock spring and the second lock spring between the shuttle and the chassis stores energy in the at least one of the first lock spring and the second lock spring. The first lock spring is substantially identical to the second lock spring.

In another aspect, a method of operating a locking device assembly is disclosed. The method includes driving a shuttle in a linear direction, with the shuttle being disposed in a chassis, compressing a first lock spring between a shuttle and a chassis to store energy in the first lock spring, and releasing the energy stored in the first lock spring to drive a locking member between a locked position and an unlocked position. The first lock spring is disposed in a first chamber of the chassis and a second lock spring is disposed in a second chamber of the chassis. The first lock spring is substantially identical to the second lock spring.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIGS. 1A-1B show a schematic representation of a locking device assembly according to the prior art;

FIG. 2 shows a locking device assembly according to some embodiments;

FIG. 3 shows a detailed view of the locking device assembly of FIG. 2 along detail 3;

FIGS. 4A-4B show a detailed view of the locking device assembly of FIG. 2 along detail 4A-4B; and

FIG. 5 shows a close-up cross-sectional view of the locking device assembly taken along line 5-5 of FIG. 4A.

### DETAILED DESCRIPTION

It should be understood that aspects of the invention are described herein with reference to the figures, which show illustrative embodiments. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

Electrified mortise locks typically employ the use of a motorized locking assembly to control the position of a locking member. The assembly typically includes a motor and associated controls, as well as a system to translate the rotational motion of the motor into linear sliding of a shuttle. In some instances, a spring is used to store energy from the movement of the shuttle, such that releasing the spring can directly or indirectly move the locking member.

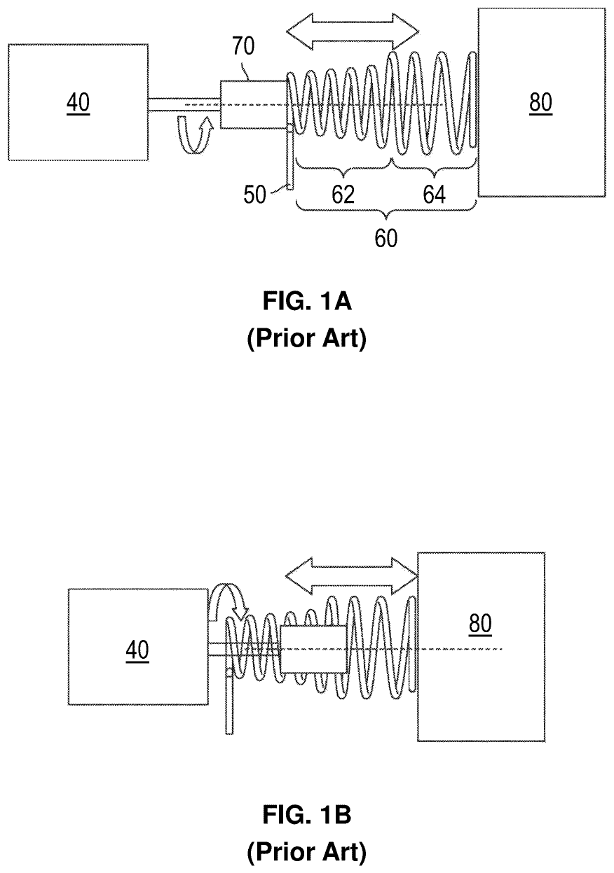

FIGS. 1A-1B show a motorized locking assembly for some conventional mortise locks. The assembly includes a motor 40 to rotate an auger 70, helping drive a spring 60 in a linear direction. The spring is coupled to a shuttle 80, such that linear motion of the spring will linearly translate the shuttle 80 relative to the auger 70. In some instances, as shown in FIG. 1A, the spring 60 includes a first portion 62 with a first spring stiffness and a second portion 64 with a second spring stiffness. The spring portions have differing stiffnesses due to their coil structure and diameter. In some instances, the first portion 62 pre-loads energy from the linear movement and the second portion 64 transfers said energy to the shuttle 80. Examples of similarly functioning locking assemblies are described in U.S. Pat. Nos. 10,465,423 and 11,187,012, both of which are hereby incorporated by reference in their entirety.

The Inventor has recognized that the variations in energy absorption between the two portions of the spring typically require high operational loads from the motor. Furthermore, the first portion, which is the portion responsible for setting the magnitude of the shuttle displacement, has a higher stiffness, thereby further increasing the power requirement of the motor. The Inventor has also recognized that the high loads of the springs shown in FIGS. 1A-1B can require higher rates of power delivered to the motor. For a locking assembly positioned in a door, which typically uses batteries, increased energy requirements can require shorter lifespans of the batteries. Replacing batteries can be tedious and expensive, and can, in some instances, briefly disrupt the ability of the door to secure the environment. Furthermore, high load requirements can deplete the lifecycle of the motor itself, requiring faster replacement, which is also a tedious and expensive process.

In view of the foregoing, the Inventor has recognized a need for an electrified locking device assembly with reduced power requirements. The locking device assembly may be able to operate at low powers to reduce the rate at which batteries (and/or other energy storage systems) and motors may need to be recharged, replaced, or otherwise maintained. Such a system may reduce overall maintenance costs and energy requirements. Of course, instances in which different benefits are offered by the systems and methods disclosed herein are also possible.

In some embodiments, a locking device assembly may include a motorized drive assembly for helping return a locking member to its original position following an incomplete door handle actuation. In some embodiments, the drive assembly may include a motor and spring-loaded actuator, which may be permitted to release energy by transferring the stored energy to a pivotable arm of the locking device assembly, as will be described in greater detail below.

In some embodiments, the motorized drive assembly may include two lock springs, each of which may be positioned in a chamber of a chassis. Each spring may be prevented from extending beyond its respective chamber in the chassis through sidewalls and a midline wall. The motorized drive assembly may also include a shuttle linearly slidable along the chassis. In contrast to the lock springs, the shuttle may cross between the chambers, as will be described in greater detail below. Accordingly, the shuttle may slide into one of the chambers and work to compress the lock spring positioned in the chamber between itself (i.e., the shuttle) and a sidewall of the chamber. In this way, the lock spring may store energy from the compression process. It should be appreciated that the other lock spring may remain uncompressed and unaffected by the compression of the neighboring spring.

The springs may be substantially identical with similar stiffnesses. In some embodiments, the lock springs of the present disclosure may have any suitable stiffness associated with operation of the arm of the system, including, but not limited to, spring stiffnesses equal to, greater than, or less than 10 N/m, 20 N/m, 30 N/m, 40 N/m, combinations thereof, and/or any other suitable stiffness.

In some embodiments, the motor of the motorized drive assembly may operate at low powers for longer operational lifetimes. The motor may operate at any suitable power, including, but not limited to, 0.25W, though powers equal to, greater than, or less than, approximately 0.25W, 0.5W, 1W, combinations thereof, and/or any other suitable power may be employed.

It should be appreciated that although the motorized drive assembly is described in relation to the locking member, the drive assemblies of the present disclosure may operate any suitable portion of a locking device assembly, including a latchbolt, a deadbolt, guard bolt, and/or any other suitable portion of the locking device assembly.

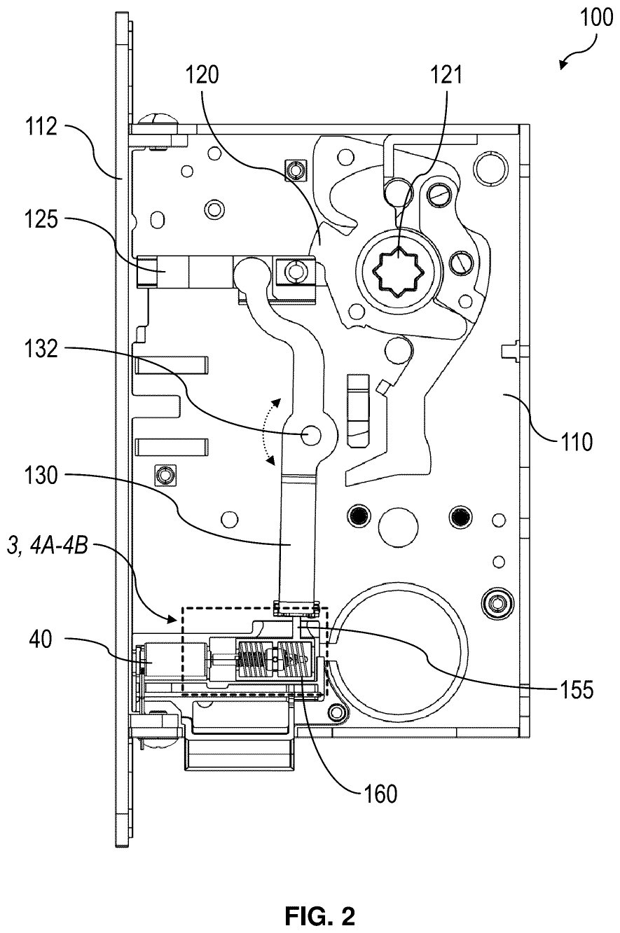

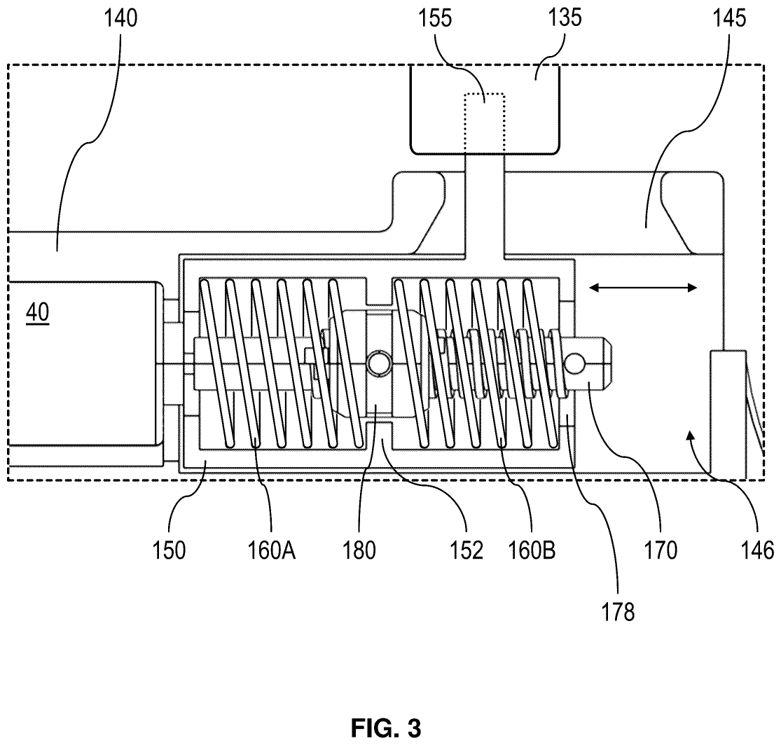

Turning to FIGS. 2-5, specific non-limiting embodiments are described in further detail. It should be understood that the various systems, components, features, and methods described relative to these embodiments may be used either individually and/or in any desired combination as the disclosure is not limited to only the specific embodiments described herein.

FIG. 2 shows a locking device assembly 100 according to some embodiments. The locking device assembly may include a body 110, which may be formed from a single sheet with the surrounding walls being bent to form a housing. The lock body 110 may hold various internal lock components and enclosed with a decorative face plate 112. The assembly 100 of FIG. 2 is shown with a side face plate removed for visual clarity, to better show the various components and interactions of the locking device assembly.

The locking device assembly may include various conventional internal lock components, including a locking member assembly 125, a hub core 120, a pivotable arm 130, and a motor 40. In some embodiments, the assembly may include a motorized drive assembly, as will be described in greater detail in relation to FIGS. 3-5. Of course, the locking device assembly may also include any other conventional feature known in the art, including, but not limited to a deadbolt, guard bolt, levers for operating the deadbolt and guard bolt, the key cylinder, and/or any other known feature and assembly.

In some embodiments, the movement of the hub core 120 may be constrained by the locking member 125, which may abut against and selectively engage the hub core 120, preventing any rotational movement of the hub core in the locked configuration. In some embodiments, the hub core 120 may be rotatable by a spindle 121, located in the center of the hub core. The spindle may be engaged with a handle on an exterior surface of the assembly, allowing a user to apply pressure to the handle to drive the hub core 120, retracting the latchbolt and/or deadbolt.

In embodiments, the locking member may be actuated with a motorized drive assembly. The motorized drive assembly may include a spring-loaded actuator 155, which may be engaged with the arm 130 of the assembly, as shown in FIG. 2. As will be described in greater detail below, the actuator 155 may be spring-loaded with lock springs 160, transferring force to the arm 130 to urge the arm to pivot about its pivot point 132 (which may be fixed to the body 110), as shown in FIG. 2. In some embodiments, this pivoting motion may permit the locking member to be disengaged from the hub core, unlocking the device.

The Inventor has recognized that the use of low stiffness springs may reduce the amount of electrical load necessary to operate the locking device assembly. Accordingly, the locking device assemblies of the present disclosure may be driven with a combination of a low-power motor and a spring-loaded actuator.

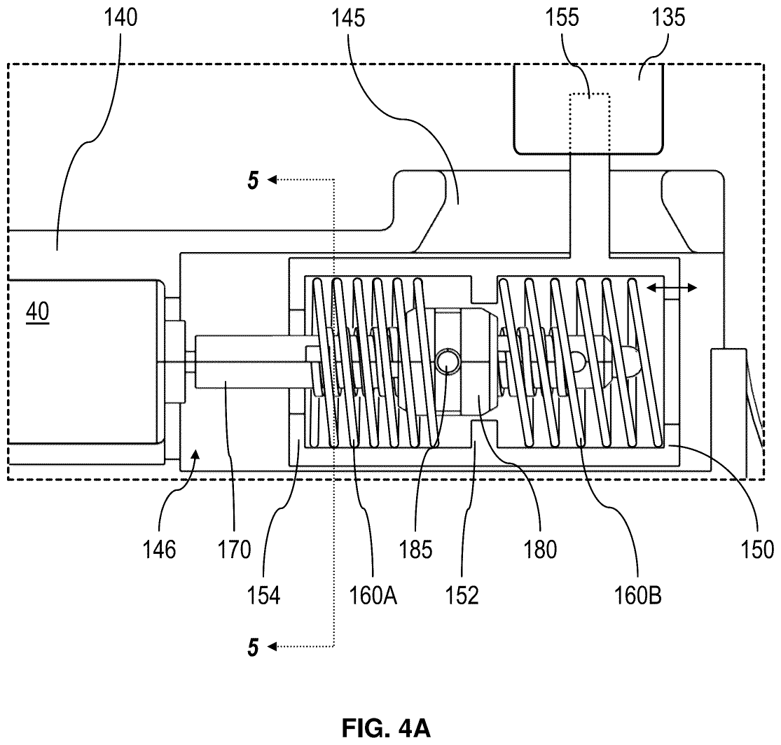

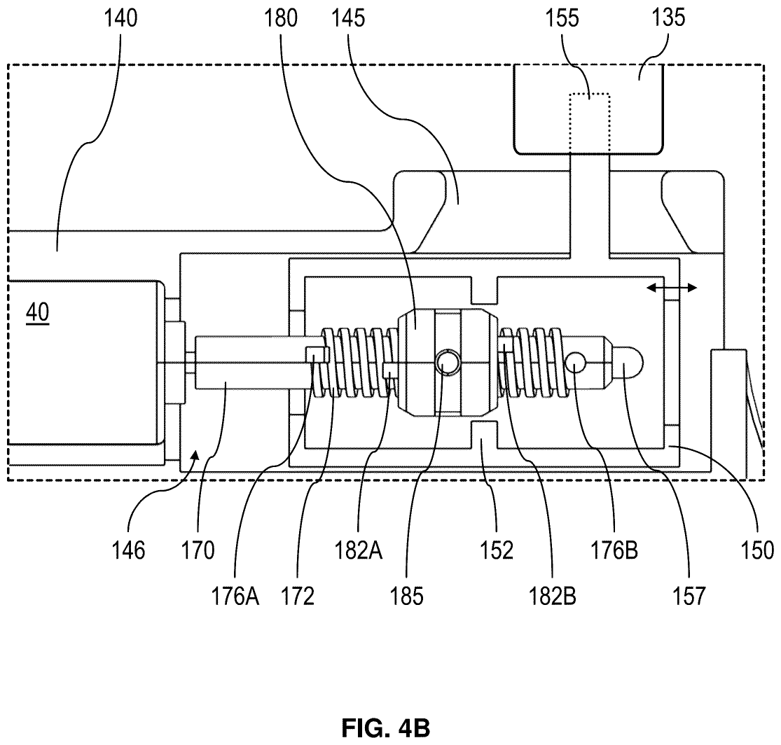

FIGS. 3-4B show a close-up view of the motorized drive assembly of the locking device assembly along detail “3, 4A-4B” in FIG. 2. In some embodiments, a locking device assembly may be driven by a motor 40 to electrically lock and unlock the assembly. In some embodiments, the motor 40 may be a low-power reversible motor. The motor 40 may drive an auger 170, such as a worm gear about its central axis. In some embodiments, the auger 170 may include threads 172 (see FIG. 4B), configured to engage with a threaded hole of a shuttle 180. The shuttle 180 may be pre-arranged on the auger 170.

In some embodiments, the shuttle 180 may be seated in a chassis 150, as shown in FIGS. 3-5. The chassis 150 may include side openings 178, as shown in FIG. 3, which may be sized to allow the auger to extend beyond the chassis 150. Accordingly, the chassis 150 may be substantially out of contact with the auger 170, permitting the auger 170 to be solely driven by the motor 40 without obstruction. It should be appreciated that the side openings 178 may have a smaller radius than the shuttle 180, preventing the shuttle 180 from exiting the chassis on either end, as shown in FIG. 4B.

In some embodiments, the motor 40 may be seated in a motor housing 140, which may be fixed to the locking device assembly, to help retain the motor in place and reduce the likelihood of dislodgement or rotation of the motor as it drives the auger 170. The motor housing 140 may include one or more features to secure the motor 40 and any associated wiring to the assembly.

In some embodiments, the chassis 150 may be floating within a cavity 146 of the motor housing 140. The chassis 150 may be shorter than the cavity 146 in a lengthwise direction, such that the chassis may be free to move along the length of a cavity 146 (as shown in the movement of the chassis between FIG. 3 and FIG. 4A). In some embodiments, the chassis 150 may be sufficiently spaced away from the motor housing 140, permitting the chassis to slide within the cavity. It should be appreciated that in some embodiments, mechanical bearing (e.g., roller bearings, linear bearings) may be used to space the chassis away from the motor housing while still permitting the chassis to slide along the motor housing cavity. The cavity 146 and chassis 150 may be shaped in a manner that prevents rotation of the chassis relative to the cavity.

In some embodiments, the chassis 150 may include an actuator 155 which may extend away from the chassis body, as shown in FIGS. 3-5. The actuator 155 may extend through an opening 145 of the motor housing 140, and into a slot 135 of the arm. The actuator 155 may be sized and shaped to confer force to the slot 135 and thereby pivot the arm (see arm 130 in FIG. 2) about its pivot point 132 (see arm pivot point 132 in FIG. 2).

In some embodiments, the chassis 150 may include two chambers separated by a midline wall 152, as shown in FIGS. 3-4B. The chambers may be equally sized, such that the midline wall 152 may be arranged at the midpoint of the chassis 50. In some embodiments, the chassis 150 may include two lock springs 160A, 160B, each positioned within a chamber of the chassis. The springs 160A, 160B may be constrained within each chamber through the sidewalls of the chassis 150. Accordingly, there may be no interaction between the two springs.

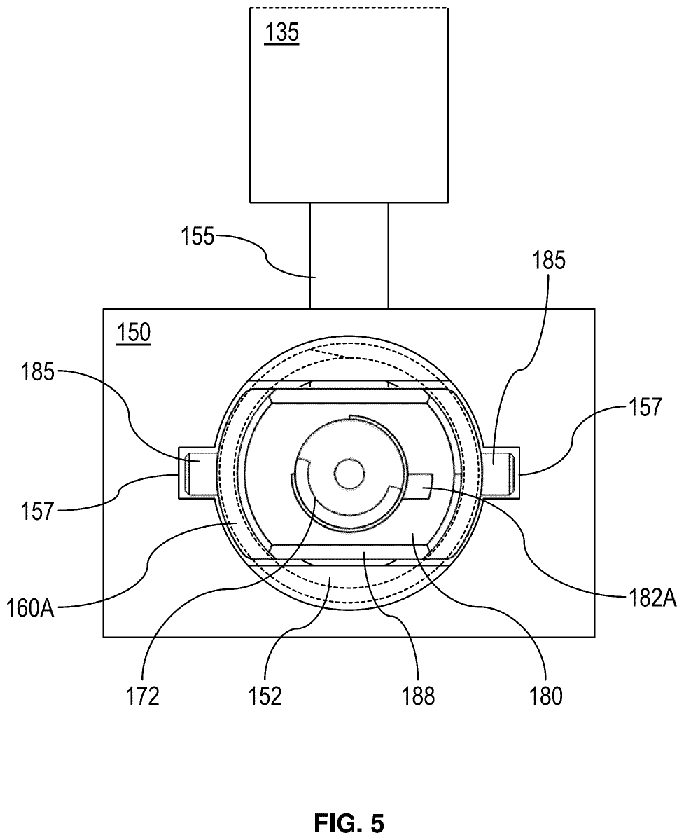

In some embodiments, the shuttle 180 may be loaded on the auger 170 and floating within the chassis 150, as shown in FIG. 4B. The shuttle 180 may include a threaded opening (not shown) which may engage with the auger threads 172, allowing the shuttle 180 to move across the length of the auger 170 upon rotation of the auger. In some embodiments, the shuttle 180 may move along the length of the auger 170 without rotating relative to the axial direction of the auger. For example, the chassis 150 may include one or more guideway slots 157 shaped to receive one or more projections 185 of the shuttle 180, as shown in FIG. 4B and FIG. 5. The projections 185 may extend out of the shuttle 180 in at least two directions (e.g., two projections oriented along the same axis, but extending out of the shuttle in opposing directions) to help prevent rotation of the shuttle 180 relative to the auger 170. Accordingly, the guideway slot 157 may help retain the orientation of the shuttle 180 relative to the chassis 150. In some embodiments, the slot 157 may extend along a substantial length of the chassis 150, permitting the shuttle 180 to freely slide along the slot 157. Accordingly, the movement of the shuttle 180 may only be restricted through the springs, and the chassis may not prevent lengthwise movement of the shuttle relative to the chassis.

In some embodiments, the shuttle 180 may be formed with flat sidewalls 188, which may be substantially aligned with the midline walls 152 of the chassis 150, as shown in FIG. 5. In this way, the shuttle 180 may readily pass the midline wall 152 without being obstructed by the wall 152. It should be appreciated that the midline walls 152 may be able to abut against the springs 160A, 160B, preventing them from extending beyond the midline walls 152, but that the shuttle 180 may pass along the length of the chassis 150 without being obstructed by the midline walls 152, as shown in FIG. 5.

In some embodiments, the projections 185 may extend further away from the shuttle 180 in a radial direction compared to the springs 160A, 160B, as shown in FIG. 5. Accordingly, the projections 185 may serve as a stop for the springs 160A, 160B. For example, as shown in FIG. 4A, when the shuttle 180 is positioned offset to the midline wall 152, the spring 160A may be compressed in between a sidewall 154 of the chassis 150 and projection 185. Thus, the projections 185 may be arranged to abut against and block the movement of the springs 160A, 160B when the shuttle 180 is positioned offset to the midline wall 152. It should be appreciated that the shuttle may include two or more projections, to further enhance the ability of the shuttle to compress the springs. For example, the shuttle 180 may include two projections 185 extending in opposing directions, sliding along similarly arranged slots 157 and abutting against spring 160A, as shown in FIG. 5.

In some embodiments, the auger threads 172 may extend a smaller radius away from the auger 170 when compared to the spring 160A, as shown in FIG. 5. In FIG. 5, spring 160A is shown in phantom to allow visualization of the other components. Accordingly, the auger threads 172 may not interfere or otherwise obstruct the movement of the springs. The springs 160A, 160B may therefore only abut against the projections 185 of the shuttle 180 and the midline wall 152 of the chassis. In this way, and in some embodiments, the springs may be free to compress or relax in accordance with their position relative to the shuttle 180 and chassis 150.

In some embodiments, the auger 170 may have one or more stop tabs 176A, 176B, as shown in FIGS. 4B-5, to prevent dislodgement of the auger 170 from the shuttle 180. The shuttle may also include one or more stop tabs 182A, 182B to abut against the stop tabs 176A, 176B of the auger, preventing the shuttle 180 from dislodging from the auger 170. In some embodiments, the stop tabs may be fixed (e.g., molded in) to their respective feature (e.g., stop tab 176A may be molded to auger 170), whereas other stop tabs may be removable from their respective feature (e.g., stop tab 176B may be press-fitted to the auger 170 such that it may be releasable from the auger) to reset the shuttle 180 and/or make any adjustments to the auger 170. The stop tabs also set the actuation distance. It should be appreciated that the structure of the stop tabs shown in FIGS. 4B-5 is illustrative and non-limiting, and any other method of preventing dislodgement of the shuttle relative to the auger may be used.

In some embodiments, the locking device assembly may include stall detection sensors, which may determine the amount of power needed by the motor to load the lock springs. For example, the sensors may prevent the motor from overrunning when the stop tabs have reached their respective end points. In this way, the motor performance may be modulated to deliver only the necessary amount of power needed, minimizing the total power needed to operate the assembly.

In some embodiments, the shuttle 180 may be driven by the motor 40 across the two chambers of the chassis 150, unobstructed by the midline wall 152, such that the shuttle may compress just one of the springs 160A, 160B. In other words, as the shuttle 180 is driven past the midline wall 152 into a chamber, it may begin to compress a spring in between itself (as will be described in detail below), and the sidewalls of the chassis 150.

Accordingly, as the motor drives the auger 170 in a rotational direction, the shuttle 180 may move in a linear direction corresponding to the rotational direction. For example, as shown in FIGS. 3-4A, the shuttle 180 may be driven into the chamber of spring 160A, compressing spring 160A against itself (e.g., through a projection 185) and the sidewall 154 of the chassis. The spring 160A may therefore store energy through the compression process. Accordingly, when the arm 130 (see FIG. 2) is released by the hub core 120, the actuator 155 of the chassis may pivot the arm 130 about its pivot point using the compression energy of the spring 160A, as the chassis returns to a position in which neither spring is compressed. Accordingly, the compression energy of each spring separately may be sufficient to pivot the arm 130, with the mechanical advantage of the levered shape of the arm (see FIG. 2). It should be appreciated that the actuator 155 may be constricted within the arm slot 135, which may further limit the movement of the chassis 150 relative to the motor housing cavity 146. In some embodiments, the presence of the spring-loaded actuator may return the latchbolt back to its original position following an incomplete door handle actuation.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

What is claimed is:

1. A locking device assembly comprising:
a locking member configured to move between a locked position and an unlocked position;
a reversible electric motor;
a shuttle operably coupled to the motor, wherein the motor is configured to drive the shuttle linearly;
a chassis operatively coupled to the locking member, wherein the shuttle is disposed inside of the chassis; and
a first lock spring and a second lock spring, wherein the first lock spring is disposed in a first chamber of the chassis, wherein the second lock spring is disposed in a second chamber of the chassis, and wherein compression of at least one of the first lock spring and the second lock spring between the shuttle and the chassis stores energy in the at least one of the first lock spring and the second lock spring, and wherein the first lock spring is substantially identical to the second lock spring.

2. The locking device assembly of claim 1, further comprising a hub core selectively engaged with the locking member, wherein disengagement of the hub core and the locking member releases the energy stored in the at least one of the first lock spring and the second lock spring.

3. The locking device assembly of claim 2, further comprising an arm disposed between the chassis and the locking member, wherein the arm is pivotable about a pivot point.

4. The locking device assembly of claim 3, wherein the chassis comprises an actuator, wherein the actuator is disposed in a slot of the arm, and wherein the actuator is configured to pivot the arm about the pivot point, and wherein the actuator is configured to drive the locking member between the locked position and the unlocked position.

5. The locking device assembly of claim 2, wherein the chassis comprises a midline wall configured to retain the first lock spring in the first chamber and the second lock spring in the second chamber.

6. The locking device assembly of claim 2, wherein the shuttle comprises at least two projections configured to compress the at least one of the first lock spring and the second lock spring against the chassis.

7. The locking device assembly of claim 2, further comprising an auger rotationally coupled to the motor, wherein the auger is operatively coupled to the shuttle.

8. The locking device assembly of claim 7, wherein the auger is configured to extend beyond the chassis through side openings of the chassis.

9. The locking device assembly of claim 2, wherein the shuttle is rotationally fixed to the chassis.

10. The locking device assembly of claim 2, wherein the chassis is disposed in a cavity of a motor housing, and wherein the chassis is slidable within the cavity.

11. A method of operating a locking device assembly, the method comprising:
driving a shuttle in a linear direction, the shuttle disposed in a chassis;
compressing a first lock spring between the shuttle and the chassis to store energy in the first lock spring; the first lock spring disposed in a first chamber of the chassis; and
releasing the energy stored in the first lock spring to drive a locking member between a locked position and an unlocked position,
wherein a second lock spring is disposed in a second chamber of the chassis, and wherein the first lock spring is substantially identical to the second lock spring.

12. The method of claim 11, wherein the step of releasing the energy stored in the first lock spring comprises disengaging a hub core from the locking member.

13. The method of claim 12, further comprising pivoting an arm disposed between the chassis and the locking member about a pivot point.

14. The method of claim 13, wherein the step of pivoting the arm about the pivot point comprises pivoting the arm with an actuator of the chassis, the actuator disposed in a slot of the arm.

15. The method of claim 12, further comprising retaining the first lock spring in the first chamber and the second lock spring in the second chamber with a midline wall of the chassis.

16. The method of claim 12, wherein the step of compressing the first lock spring between the shuttle and the chassis comprises compressing the first lock spring against at least two projections of the shuttle.

17. The method of claim 11, wherein the step of driving the shuttle in the linear direction comprises driving an auger with a motor, the auger rotationally coupled to the motor, wherein the auger is operatively coupled to the shuttle.

18. The method of claim 17, further comprising extending the auger beyond the chassis through side openings of the chassis.

19. The method of claim 11, wherein the shuttle is rotationally fixed to the chassis.

20. The method of claim 11, further comprising sliding the chassis within a cavity of a motor housing.
